(19) United States
(12) Patent Application Publication
(10) Pub. No.: US 2007/0047488 A1
(43) Pub. Date: Mar. 1, 2007

(54) Method and network element for distributing and directing data packets during a handover of a mobile transceiver station from a first radio cell to a second radio cell within a mobile communication network

(75) Inventors: Robert Eberl, Wien (AT); Alois Huber, Wien (AT); Bernd Kurzmann, Wien (AT)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 10/579,236

(22) PCT Filed: Oct. 25, 2004
(86) PCT No.: PCT/EP04/52657

§ 371 Date: May 12, 2006

(30) Foreign Application Priority Data
Nov. 12, 2003 (DE) 103 52 771.0

(51) Int. Cl. H04Q 7/00

(52) U.S. Cl. 370/331

(57) ABSTRACT

A method and network element for distributing and directing data packets during a handover of a mobile transceiver station from a first radio cell to a second radio cell within a mobile communication network, especially during a packet-switched cell handover. The network element of the mobile communication network via which a communication to the second radio cell is directed is provided with data packets that have been duplicated by at least a part of the data packets forwarded to the first radio cell. In this manner, the network element determines the type of distribution and direction of the duplicated data packets without any additional signaling.

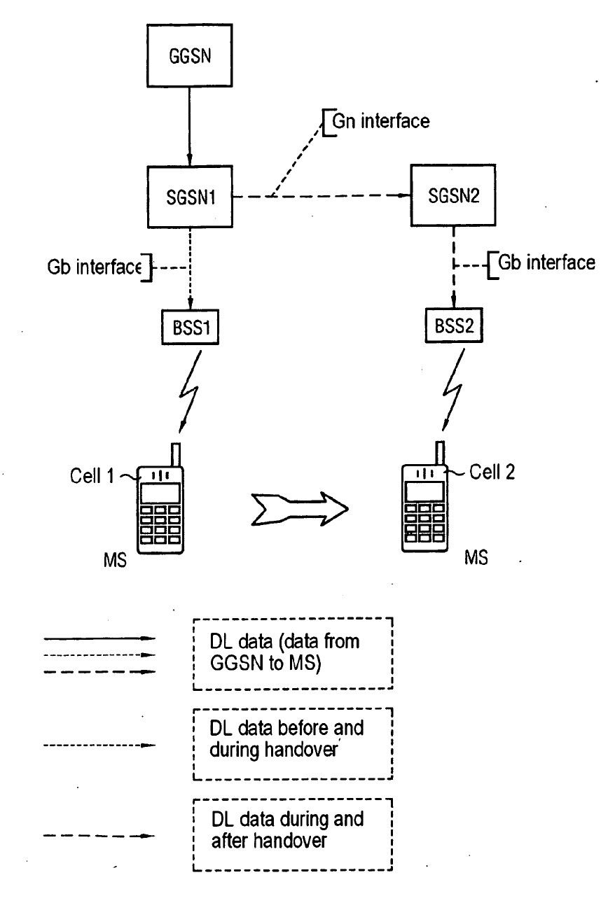

### CROSS REFERENCE TO RELATED APPLICATIONS

This application is based on and hereby claims priority to PCT Application No. PCT/EP2004/052657 filed Oct. 25, 2004 and German Application No. 10352771.0 filed Nov. 12, 2003, the contents of which are hereby incorporated by reference.

### BACKGROUND OF THE INVENTION

The invention relates to a method and a network element for distributing and routing data packets during a handover of a mobile transceiver station from a first radio cell to a second radio cell within a mobile communication network. The method and the network element are suitable in particular for the packet-switched cell handover method (PS handover; PS=packet switched).

Packet-oriented switching is supported in GSM systems. In packet-switched data communication in GSM (GPRS) a method referred to as “PS handover” is currently being standardized. PS handover is intended to enable the shortest possible switchover times when a mobile station (MS) is handed over from one cell to another. In this case resources are already reserved in advance in the destination cell, which resources can be accessed by the MS immediately after the handover. A further aim is to minimize the interruption time by suitable data stream distribution mechanisms. For example, with certain data streams the data stream can be sent into both cells during the handover phase.

Packet-switched data streams can be classified into different categories (see also 3GPP TS 23.107):

Real Time

These are data streams with short data transit delays. From the user perspective the transit delay is of course that which occurs between the source and the user. In this document, however, only the path between SGSN and MS is meant. A further typical feature of real time services is also a reserved bandwidth, i.e. the system (in this document from SGSN←→MS) reserves bandwidth exclusively for this user). The specification 23.107 (/1/) also distinguishes between “streaming” and “conversational”. The difference lies here essentially in the transit delay, which is significantly shorter in the case of conversational mode than in the case of streaming mode.

Non Real Time

In this case the transit delays are significantly greater than in the case of real-time services. Also, usually no bandwidth is reserved that is exclusively available to the user.

Lossy

Lossy data streams can tolerate a certain loss of data in the network. A higher layer can provide a mechanism for this (e.g. repeat request for packets) or not.

Lossless

With this type no packet loss can be accepted. At the interfaces an extended data link layer is made available which detects errors and gaps in the data stream and then requests the respective packets for retransmission.

Typical combinations of both characteristics are:

Conversational Real-Time Service

With this service (e.g. voice transmission) the emphasis is on the short transit delay. The data streams are essentially transmitted as lossy data. In the switchover during PS handover the resulting data loss can be tolerated. This should be kept to a minimum by suitable measures. Although it is theoretically possible to transmit the data losslessly, such a service does not work in practice.

Streaming Real-Time Service

In this case the same essentially applies as in conversational services. A slight difference relates to the fact that the streaming service can rather be transmitted losslessly. It should, however, be borne in mind that the network is geared to acknowledgements of the MS and as soon as these are absent (switchover) the data stream is halted. Each interruption also increases the transit delay, at least temporarily, since the entire data stream has to be transmitted.

Non-Real-Time Services

With these, both lossless and lossy transmission are possible. Moreover, the transit delay plays only a subordinate role.

The 3GPP TS 23.060/1/offers a technical overview of the operating principle of packet switching in GSM. References to the interfaces cited in the following can also be found there. PS handover is currently in the standardization phase and no standard exists at the present time.

The routing of different types of data streams during the handover phase is shown below with reference to the FIGURE and a systematic procedure for their different types is described.

1. A mobile transceiver station, in particular a mobile station (MS), has a packet-switched (PS) connection from the GPRS-supporting network element SGSN via the base station subsystem BSS, which typically includes a controller and a base station. This is subsequently referred to also as the “old” side. Other network elements are also involved in the connection. The connections at the Gn interface (SGSN1-SGSN2) (/7/) and at the Gb interface (/4/) “new” side (SGSN2-BSS2) do not yet exist at this time.

2. The BSS1 requests a PS handover for the MS from the SGSN1. The BSS1 sends a corresponding message to the SGSN1 and also makes the destination known therein. In this case the destination is located within the BSS2 which is controlled by the SGSN2.

3. Since in this case the SGSN1 cannot reach the BSS2 directly, the SGSN1 sends a message to the SGSN2.

Said SGSN2 notifies the BSS2 of the pending handover and the BSS2 reserves resources for the MS. The corresponding resources are also reserved at the interface SGSN2 and BSS2. At this time, however, the BSS2 still has no physical connection, i.e. the MS is still not accessible to the BSS2. The SGSN2 too, of course, must make preparations.

4. After the reservation has been completed on the new side and the SGSN1 has been notified thereof, the SGSN1 sends a message to the BSS1 in order to signal that the new side is ready. The BSS1 then sends a message to the MS, which then switches over to the new side.

At this time the following connections exist:

SGSN1-BSS1-MS “old” connection

SGSN1-SGSN2-BSS2

5. Following the successful handover, the MS has registered on the new side and the SGSN2 notifies the SGSN1 of this. The latter also initiates the release of the resources in the BSS1 and between SGSN1 und BSS1.

Between the time at which the resources were reserved and the MS registers on the new side it is not possible to determine where exactly the MS is located. As soon as the SGSN1 sends the BSS1 the release for the handover, it is no longer possible for the SGSN1 to see where the MS now is (until the MS registers on the new side). This is also no longer possible for the BSS1 as soon as it gives the MS the command to switch over.

It is necessary to adopt different measures, depending on the type of data stream. For data streams with real-time requirements the interruption times should be, as short as possible. It was proposed to duplicate the data arriving in the SGSN1 from the GGSN (Gateway GPRS Support Node) and send it simultaneously to the old and the new side.

For this it is, however, necessary for the BSS2 to be able to send data “blind” on the new side. If, for example, a protocol is used which requires acknowledgements from the MS, blind sending is not possible. This also applies analogously to the BSS1, of course.

This gives rise to the following problem: If the SGSN1 duplicates data and forwards it to the SGSN2 and the latter forwards it in turn to the BSS2, and if the BSS2 cannot send the data blind, a data bottleneck will form. If the mobile station then switches over to the BSS2, it would receive some data that it has already received earlier from the BSS1. The decision as to whether data can be sent blind or not can only be made by the BSS2.

This applies analogously to the BSS1: In principle it is possible for the MS, after it has received the command to switch over, to return to the old cell. If the BSS1 also cannot transmit blind, a data bottleneck would form here too. The problem here is not so much that the data is received twice, but that the overall delay increases due to the data bottleneck produced.

Furthermore it has been proposed in GB 0300080.9 to control the double reception of duplicated and original data packets on the basis of a sequence number. The sequence number indicates as of which packet of the duplicated data stream packets are to be forwarded to the mobile station MS on the “new” side via the new path. For this purpose an additional overhead for the signaling of the sequence number is necessary.

### SUMMARY OF THE INVENTION

One possible object of the invention relates to developing a coordinated method and system which improves the above described mechanisms.

The inventor propose a method for distributing and routing data packets during a handover from a mobile transceiver station from a first radio cell to a second radio cell within a mobile communication network, in particular during a packet-switched cell handover, with data packets being supplied to a network element of the mobile communication network via which a connection to the second radio cell is routed, said data packets having been duplicated from at least a part of data packets routed to the first radio cell. The type of distribution and routing of the duplicated data packets is determined by the network element without additional signaling. Corresponding units for performing the method are embodied in a network element of the mobile communication network.

Advantages and further details of the method and network element will emerge from the embodiments described below.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

The FIGURE shows in a schematic representation a typical network configuration in which a handover of a mobile station from a first radio cell to a second radio cell can take place.
The SGSN1 has a connection to the BSS and to the MS via which the data packets are (can be) sent.
From the SGSN1 to the SGSN2 there exist connections (/7/) by which data streams or packets can be delivered to the SGSN2.
The resources via which the data packets can be sent are assigned by the SGSN2 to the BSS2/4/.
The characteristics of the data streams (real time, loss tolerant, etc.) are known to the SGSN1.
These characteristics are also known to the SGSN2.
The connections (SGSN1→SGSN2) are uniquely assignable to the respective data streams.
This also applies to the resources SGSN2→BSS2 (/4/)

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In order to comply with the characteristics of the data streams, the BSS2, for example, would have to signal to the SGSN2 whether blind transmission into the new cell is possible. The SGSN2 would have to forward this in turn to the SGSN1.

For data streams with lossless transmission it must be guaranteed that after the handover all packets not yet acknowledged will be kept available for the MS.

The start of the duplication can be left to the individual implementation in the SGSN1.

The SGSN1 duplicates all data packets for which a connection to the SGSN2 is present. For a data stream which accepts no loss of data, all data packets which are still resident in the buffer of the SGSN1 (i.e. all packets not yet acknowledged by the MS) must be duplicated and sent via the corresponding connection to the SGSN2. In this way the SGSN2 is provided with all the data packets that it needs to continue the data transmission without gaps.

For the other data streams it can be decided on an individual basis which data and whether data is duplicated and forwarded. The possibilities are either only to duplicate and forward the incoming data or also to duplicate and forward the buffered data. This can be left to the implementation. An important point for the routing of the different data streams is that each individual network element (e.g.: SGSN1, SGSN2, BSS2) makes a decision, taking into account the available information (e.g.: SNDCP (/6/)/LLC (/5/) mode), on what is to happen with received packets and which action is initiated in the respective node: buffer, forward or discard. The available information for routing the data streams is different from network element to network element.

In the routing of the data streams, as described in the problem addressed, the aim is to prevent both the loss of packets (SNDCP (/6/)/LLC (/5/) ACK) and the double reception of packets in the MS. In the following it will be explained how the mechanism can be implemented in the SGSN2 and in the BSS2. If data packets from the SGSN1 are received in the SGSN2, the latter has the following options. Depending on which information (e.g.: SNDCP (/6/)/LLC (/5/) mode) is available to the SGSN2, the SGSN2 decides how the received data will be processed. The SGSN2 sends all or a part of the data streams to the BSS2.
In lossless operation (SNDCP (/6/)/LLC (/5/) acknowledged mode) of a data stream, the data arriving from the SGSN1 is stored in the SGSN2. These packets are disassembled in SNDCP (/6/)/LLC (/5/) acknowledged mode.
In lossy operation (SNDCP (/6/)/LLC (/5/) unacknowledged mode) the SGSN2 forwards the data to the BSS2 or it discards it immediately. All the other data streams can be sent to the BSS2.

The following procedure is used for the data that arrives in the BSS2: The BSS has two options for handling the received data. Either the BSS2 starts a blind sending of the data over the air if possible (protocol dependent and implemented) or in the case of streams where that is not possible (e.g. no radio resources present), data is discarded until the MS has registered on the new side.

Advantages:

1. Discarding the packets prevents the received packets being buffered in the BSS, which is associated with the significant disadvantage of the packets being stored in the BSS according to their “PDU lifetime”. Due to the resulting delay these packets would be transmitted to the MS once again on the new side, although the MS has already received them on the old side. In order to counteract the double reception of these packets, the received packets are not stored in the BSS, but are deleted (if a “blind sending” is not possible). If an MS receives a packet both on the old and on the new side, it may not be able (e.g. in SNDCP/LLC unacknowledged mode) to recognize the duplicated packets as such and discard them. This leads to the degradation of the service.

2. No additional signaling between the network elements is necessary.

3. The method enables a clear decision-making process in the respective network elements.

The exemplary embodiment describes the case of PS handover with SGSN switchover. The method can also be applied if the BSS2 is directly connected to the SGSN1 (i.e. without SGSN switchover). In this case the interface between SGSN1 and SGSN2 is unnecessary.

The method can also be applied when BSS1 and BSS2 are one and the same BSS. From the viewpoint of the SGSN these are regarded as logically separate BSSs.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for distributing and routing data packets during a packet-switched handover of a mobile transceiver station from a first radio cell to a second radio cell within a mobile communication network, comprising:
during the packet-switched handover, duplicating at least a potion of data packets routed to the first cell;
sending duplicated data packets to a network element associated with the second radio cell of the mobile communication network;
routing a connection to the second radio cell via the network element;
wherein a type of distribution and routing of the duplicated data packets is determined by the network element associated with the second cell, without additional signaling.

12. The method as claimed in claim 11, wherein the mobile transceiver station is a subscriber terminal device and the network element is a base station.

13. The method as claimed in claim 11, wherein the mobile transceiver station is a subscriber terminal device and the network element is a controller.

14. The method as claimed in claim 11, wherein the mobile transceiver station is a subscriber terminal device and the network element is a General Packet Radio Service (GPRS)-supporting network node.

15. The method as claimed in claim 11, wherein the type of distribution and routing of the duplicated data packets is selected from the group consisting of buffering, forwarding and discarding.

16. The method as claimed in claim 12, wherein the type of distribution and routing of the duplicated data packets is selected from the group consisting of buffering, forwarding and discarding.

17. The method as claimed in claim 13, wherein the type of distribution and routing of the duplicated data packets is selected from the group consisting of buffering, forwarding and discarding.

18. The method as claimed in claim 14, wherein the type of distribution and routing of the duplicated data packets is selected from the group consisting of buffering, forwarding and discarding.

19. A network element associated with a second radio cell to distribute and route data packets during a packet-switched handover of a mobile transceiver station from a first radio cell to the second radio cell within a mobile communication network, has the following means]comprising:
means for receiving data packets which have been duplicated from data packets routed to the first radio cell;
means for distributing and routing data packets; and
means, provided only at the network element associated with the second cell, for determining a type of distribution and routing of the data packets that were duplicated, without additional signaling.

20. The network element as claimed in claim 19, wherein the network element is a base station.

21. The network element as claimed in claim 19, wherein the network element is a controller.

22. The network element as claimed in claim 19, wherein the network element is a General Packet Radio Service (GPRS)-supporting network node.

23. The network element as claimed in claim 19, wherein the type of distribution and routing of the duplicated data packets is selected from the group consisting of buffering, forwarding and discarding.

24. The network element as claimed in claim 20, wherein the type of distribution and routing of the duplicated data packets is selected from the group consisting of buffering, forwarding and discarding.

25. The network element as claimed in claim 21, wherein the type of distribution and routing of the duplicated data packets is selected from the group consisting of buffering, forwarding and discarding.

26. The network element as claimed in claim 22, wherein the type of distribution and routing of the duplicated data packets is selected from the group consisting of buffering, forwarding and discarding.
